(19) United States
(12) Patent Application Publication
(10) Pub. No.: US 2013/0168960 A1
(43) Pub. Date: Jul. 4, 2013

(54) METHOD AND APPARATUS FOR POLE-SLIP DETECTION IN SYNCHRONOUS GENERATORS

(71) Applicants: Milan Kalinka, Solivar (SK); Miroslav Novak, Liberec (CZ); Tomas Jelen, Praha (CZ); Roman Taragel, Poprad (SK)

(72) Inventors: Milan Kalinka, Solivar (SK); Miroslav Novak, Liberec (CZ); Tomas Jelen, Praha (CZ); Roman Taragel, Poprad (SK)

(73) Assignee: ComAp a.s., Prague (CZ)

(21) Appl. No.: 13/722,262

(22) Filed: Dec. 20, 2012

Related U.S. Application Data
(60) Provisional application No. 61/582,715, filed on Jan. 3, 2012.

(51) Int. Cl. H02P 11/00

(52) U.S. Cl. CPC H02P 11/00
USPC 290/7

(57) ABSTRACT

A system and method for predicting a pole slip in a synchronous generator is provided. The system includes a stator voltage frequency detector to determine the frequency of the stator voltage, a mechanical frequency detector to determine the rotational speed of the rotor and a prediction unit that is operative to disconnect the generator from a power grid if it determines that that a pole slip is likely based on comparison of the frequency of the stator voltage and the rotational speed of the rotor.

### RELATED APPLICATIONS

This application is based on and claims priority to non-provisional Patent Application No. 61/582,715 filed Jan. 3, 2012, the contents of which are herein incorporated by reference.

### FIELD

The present disclosure generally relates to synchronous generators, and in particular to rotating magnetic field synchronous generators.

### BACKGROUND

Power generators with an apparent power rating above approximately 5 kVA are generally constructed as rotating magnetic field or revolving field synchronous generators. Such machines have the field windings wound on the rotating member of the machine (i.e., the rotor) and the armature wound on the stationary member (i.e., the stator). A low power, low voltage, dc current is conventionally fed to the field windings on the rotor using, for example an excitation circuit also known as a excitation system or exciter that may include an ac/dc converter, dc battery or other dc current generator. The dc current is supplied to the field windings using, for example, a rotary electrical interface such as a set of slip rings and/or brushes. Alternatively, the excitation circuit may include a shaft mounted exciter and a diode-bridge mounted on the rotor, thereby creating an electromagnet on the rotor. The rotor is turned by a prime mover such as an internal combustion engine, a steam turbine, water turbine or any other suitable engine, turbine or machine, thereby creating a rotating magnetic field (i.e., rotor magnetic field). The rotor magnetic field is constant in strength and rotates around the machine at the rotation speed of the rotor. Under normal operation, the magnitude of the rotor magnetic field is directly proportional to the dc current that excites the rotor windings (i.e., the field current).

The stator generally comprises three sets of coils of wire (i.e., windings) that are embedded into the stator (typically made of iron). The rotation of the rotor magnetic field induces a sinusoidal voltage at each coil or winding. The induced sinusoidal voltages are identical in magnitude and frequency but shifted 120 degrees with respect to each other. The three coils are distributed 120 degrees apart on the stator in such a manner to obtain three balanced and sinusoidal voltages having very little harmonic content to avoid damaging the generator. The magnitude of the voltage induced into the stator windings is a function of the intensity of the rotor magnetic field, the rotational speed of the rotor and the number of turns in the stator windings.

The frequency of the induced voltages relates to the rotational speed of the rotor and the number of its poles. When the generator is coupled to a distribution network (also called grid or mains), the frequency of the induced stator alternating voltages is a system parameter for all generators connected to that network. In a two-pole machine with a 60 Hz output supply current, the speed of rotation of both the rotor (i.e., the speed of the rotor magnetic field) and the stator magnetic field will be 60 revolutions per second or 3600 rpm. The induced voltages in the three phase stator windings generate their own magnetic field (i.e., the stator magnetic field). The strength of the stator magnetic field depends on the current flow in the stator winding.

When the torque applied to the rotor is zero (i.e., when the machine is producing no power in the no load state), the magnetic fields of the rotor and the stator are perfectly aligned. The instant torque is introduced to the rotor by the prime mover, and throughout normal operation of the generator, the magnetic fields in the generator come out of alignment and a small angle between the magnetic fields is created. This angle is called the load angle or the torque angle (β). During stable or steady state conditions, the load angle (β) is generally less than 90-110 degrees.

During steady state, the load angle creates a force between the fields opposing the acceleration of the machine and energy flow from the machine (i.e., the generator) to the system (i.e., the grid). The rate of energy flow or power output of the machine is proportional to the strength of the magnetic fields and the sine of the load angle.

As the prime mover accelerates, the load angle increases and the force opposing the rotation increases and the machine speed stays constant. Generally, if the strengths of either magnetic fields is increased, the power output of the machine remains constant, but the increased forces between the fields pull the rotor back towards its no load position and the load angle decreases. In other words, increasing the rotor magnetic field strength decreases the load angle (with power output staying constant) and increasing the speed of rotation of the rotor (e.g., by the prime mover) increases the load angle and the power output increase.

The maximum power output for the strength of the magnetic poles is found when the load angle of the generator is approximately 90-110 degrees. If the power input to the generator starts to push the rotor past the 90-110 degree position, the retarding forces on the rotor start to decrease and the rotor speed will start to accelerate and travel faster than the rotating magnetic field of the armature. At this point, the rotor magnetic flux is starting to slip with respect to the stator magnetic flux. If the rotor accelerates such that the rotor takes an extra revolution than the rotating magnetic field (i.e., a load angle of 360 degrees or more), a pole slip has occurred. Immediately before, during and after the occurrence of a pole slip, the machine will undergo severe mechanical stresses as magnetic forces apply torques on the shaft to first try to brake the machine and then accelerate it. Such braking and acceleration forces often damage the generator or decrease the life of a generator.

The foregoing description of the operation of a generator and the occurrence of a pole slip was explained by reference to a separate rotor magnetic field and a separate stator magnetic field. In reality, however, there is only one magnetic field in a generator. This generator magnetic field is found in the airgap between the rotor and the stator and can be thought of as the resultant magnetic field produced by the combination of the rotor and stator magnetic fields. Mathematically, the resultant or airgap flux (Φr) is equal to the summation of the flux of the stator field (Φs) and flux of the rotor field (Φf):

Φr=Φs+Φf

Because pole slips are capable of causing significant stress and potential damages to generators, it has become important to diagnose the occurrence of a pole slip and disconnect the generator from the grid by removing the dc current supply from the rotor windings promptly upon such an event. Conventionally, so-called impedance methods or schemes are currently implemented to detect the occurrence of a pole slip and shut down the generator to avoid continued damage to the machine. These impedance methods are generally complicated and expensive to implement and include the measurement of both active and reactive power. More importantly, they are incapable of “predicting” a pole slip. Instead, such conventional methods simply detect when a pole slip has actually occurred.

While large generators (e.g., generators that are capable of producing 30-200+MW of active power) are generally more likely to “survive” several pole slips, smaller generator (e.g., generators that only produce on the order of 1 MW of active power) are less likely to physically survive a pole slip. As such, a need exists for an apparatus and method of predicting when a pole slip will occur instead of merely reacting to the occurrence of a pole slip.

In one aspect of the present disclosure, an improved device for determining the probability or likelihood of a pole slip is described. The ability to predict a pole slip condition can allow actions to be taken before a pole slip occurs and prevent the undesirable consequences of the pole slip.

In another aspect of the present disclosure, detection devices are described. The detection devices or sensors collect information regarding the characteristics of various aspects of an operating generator and supply this information to other devices that can predict a pole slip condition.

In still another aspect of the present disclosure, a synchronous generator system is described. The synchronous generator system includes detection devices for collecting information regarding the synchronous generator and supply this information to a device that is able to predict a pole slip condition. The system may further include a circuit breaker or other device that can disconnect the generator from the power grid if a pole slip condition is detected.

### BRIEF DESCRIPTION OF THE DRAWINGS

The disclosure will be more readily understood in view of the following figures.

FIG. 1 illustrates a rotating magnetic field synchronous generator and the magnetic flux associated with the rotor (i.e., the rotor or field flux);

FIG. 2 illustrates a rotating magnetic field synchronous generator and the magnetic flux associated with the stator (i.e., the stator or armature flux);

FIG. 3 illustrates a rotating magnetic field synchronous generator and the resultant or airgap flux produced by the interaction of the rotor flux and the stator flux;

FIG. 4 illustrates a rotating magnetic field synchronous generator with the rotor positioned at a load angle of 45 degrees;

FIG. 5 illustrates a rotating magnetic field synchronous generator with the rotor positioned at a load angle of 110 degrees, at the edge of the stability zone;

FIG. 6 illustrates a rotating magnetic field synchronous generator with the rotor positioned at a load angle of 270 degrees, 90 degrees from the occurrence of a pole slip;

FIG. 7 illustrates a block diagram of a prime mover coupled to a rotating field synchronous generator in accordance with one embodiment of the present disclosure;

FIG. 8 illustrates a block diagram of an excitation circuit coupled to a rotating field synchronous generator in accordance with one embodiment of the present disclosure;

FIG. 9 illustrates an example of a prime mover in accordance with one embodiment of the present disclosure;

FIG. 10 illustrates the output voltage induced in the stator windings relative to the position of the flywheel in accordance with one embodiment of the present disclosure;

FIG. 11 illustrates an exemplary flow chart for a method of predicting a pole slip in a synchronous generator in accordance with one embodiment of the present disclosure;

FIG. 12 illustrates another exemplary flow chart for a method of predicting a pole slip in a synchronous generator in accordance with a second embodiment of the present disclosure;

FIG. 13 illustrates another exemplary flow chart for a method of predicting a pole slip in a synchronous generator in accordance with a third embodiment of the present disclosure; and

FIG. 14 illustrates a block diagram of an excitation circuit coupled to a rotating field synchronous generator in accordance with another embodiment of the present disclosure.

### DETAILED DESCRIPTION

As used herein, the following terms have the meanings ascribed thereto as set forth below. “Logic” may refer to any single or collection of circuits, integrated circuits, processors, transistors, memory, combination logic circuit, or the like or any combination of the above that is capable of providing a desired operation(s) or function(s). For example, logic may take the form of one or more processors or microcontrollers executing instructions from memory, application specific circuits (ASICs), state machines, programmable logic arrays, integrated circuits, discrete circuits, etc. that is/are capable of processing data or information, and any suitable combination(s) thereof.

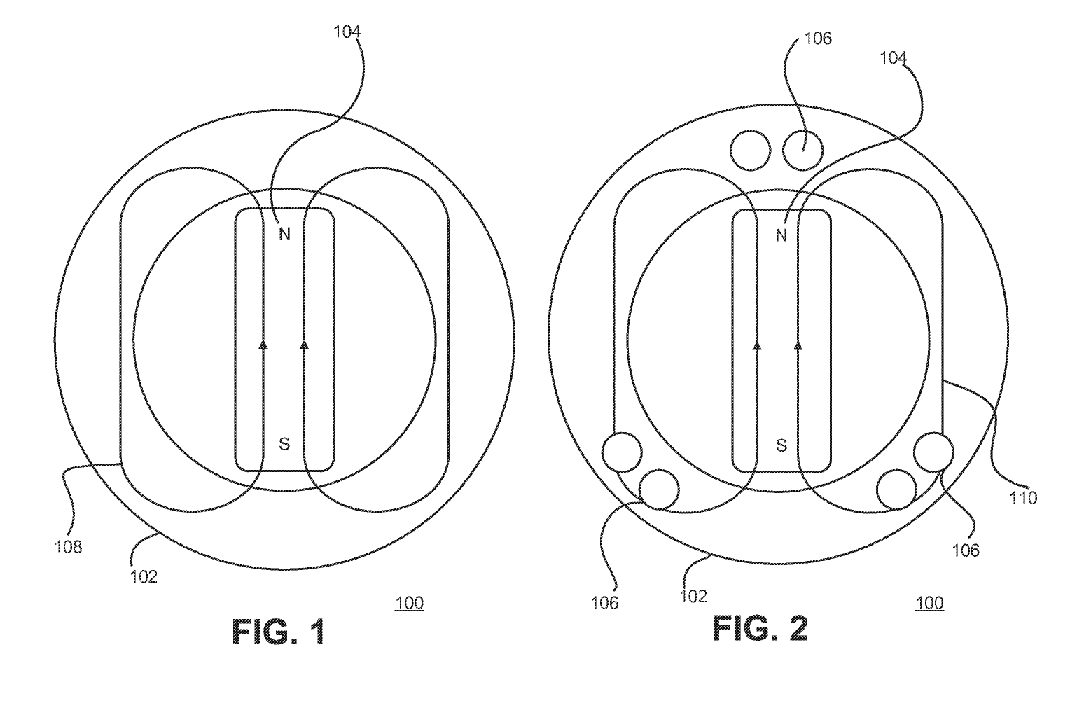

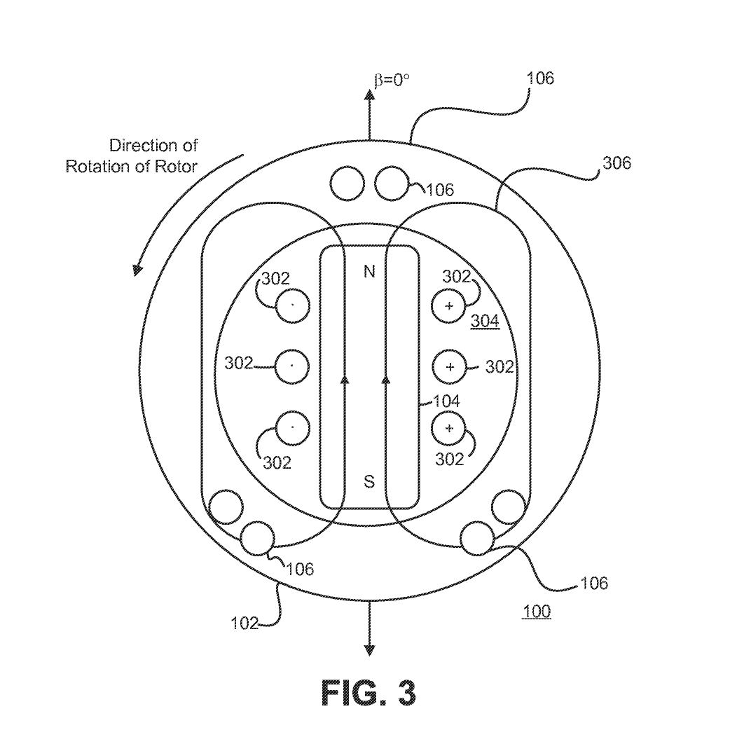

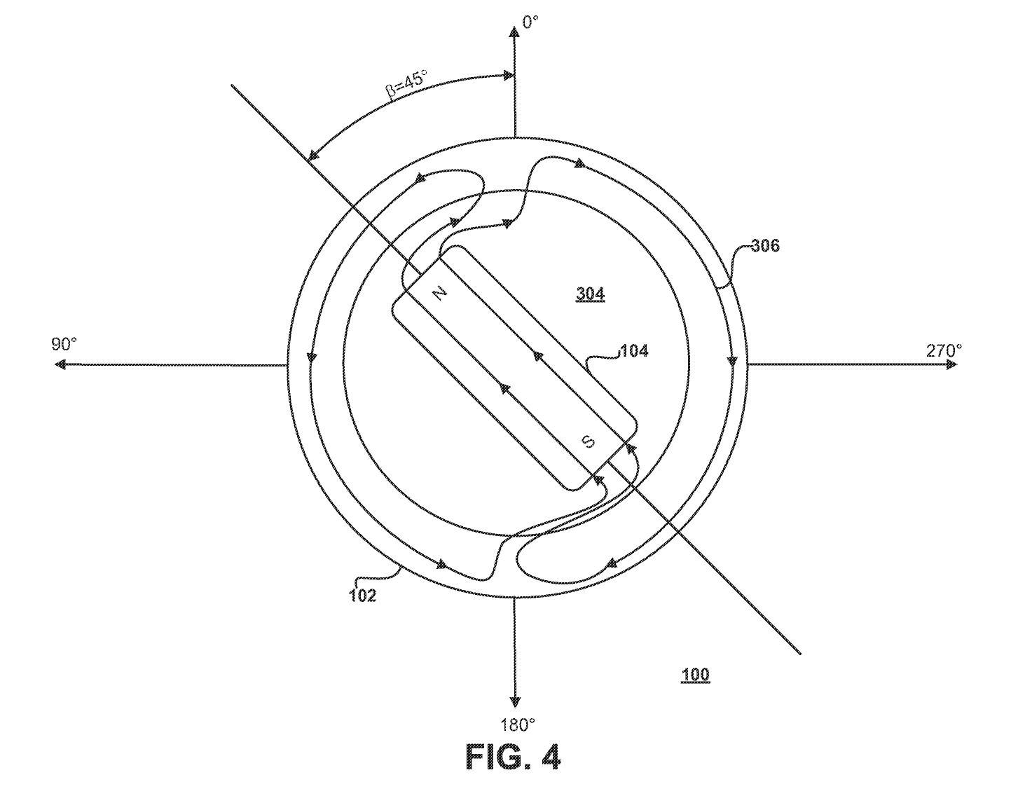

With reference to FIGS. 1-3, a conventional rotating magnetic field synchronous generator 100 is illustrated. Generator 100 includes stator 102 and rotor 104. As is known in the art, stator 102 is conventionally constructed of insulated metal sheets that contain grooves with copper windings and rotor 104 is conventionally an electromagnet made of steel with symmetrically distributed longitudinal grooves containing excitation windings 302. Stator 102 includes three sets of stator coils or windings 106 that are positioned 120 degrees apart from one another. Those of skill in the art will recognize that other materials and designs may be used in the manufacturing and implementation of stator 102 and rotor 104 without deviating from the spirit of this disclosure. For example, rotor 104 may be a permanent magnet without windings instead of an electro magnet. FIG. 1 illustrates the rotor magnetic flux (Φf) at 108 and FIG. 2 illustrates the stator magnetic flux (Φs) at 110. FIG. 3 illustrates airgap 304 and the resultant or airgap flux (Φr), at 306. For purposes of this disclosure, the direction of the rotor 104 is counterclockwise as shown in FIG. 3.

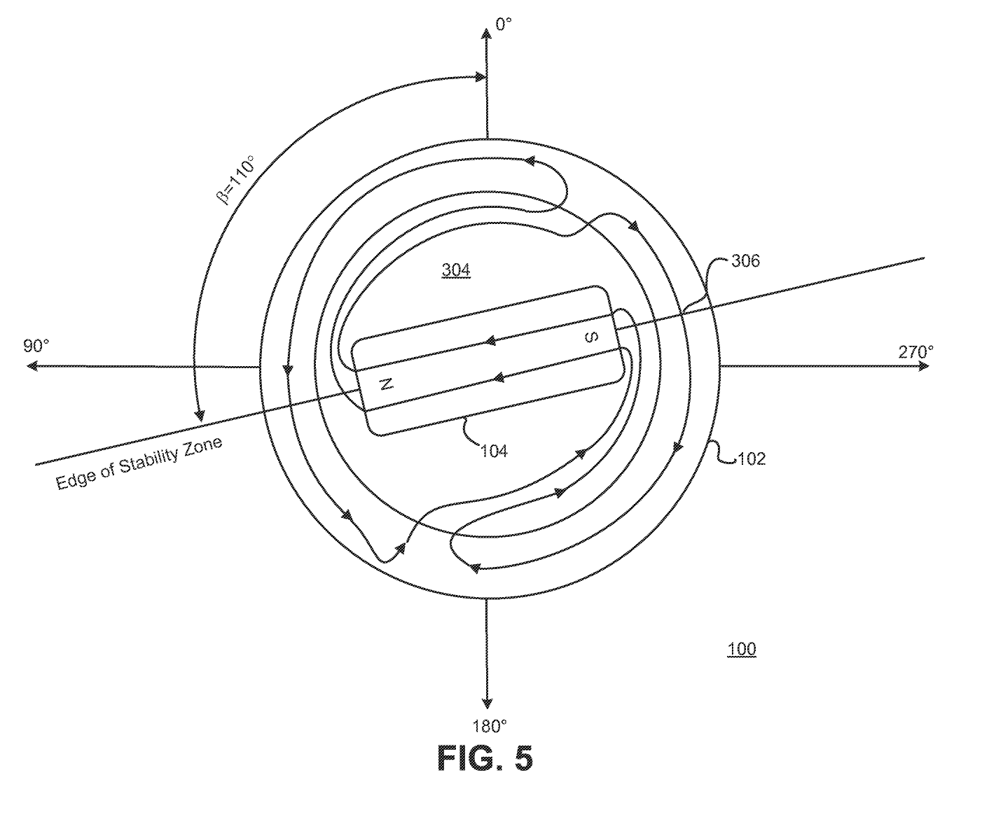

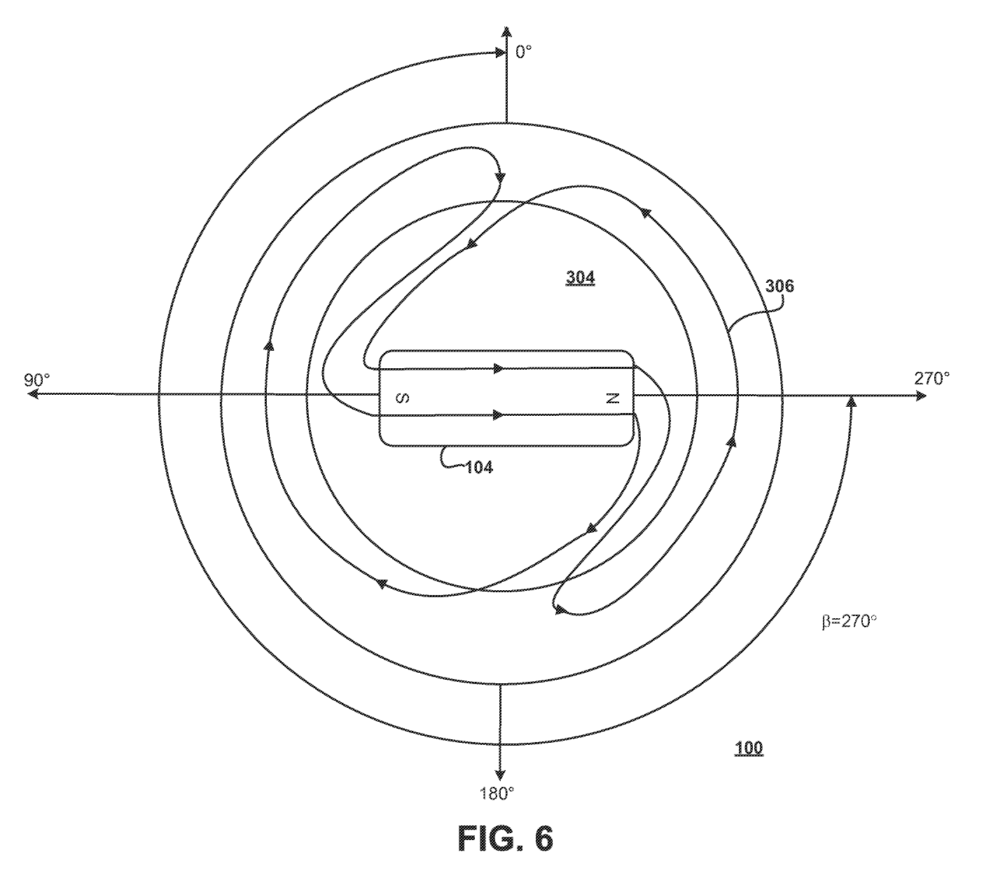

FIGS. 3-6 illustrate the rotor 104 in different positions with respect to stator 102 for the purposes of demonstrating different load angles (β). FIG. 3 shows the generator 100 at rest with no load. As such, the load angle (β) is 0 degrees. FIG. 4 shows the generator 100 in operation in steady state with the load angle (β) at 45 degrees. FIG. 5 shows the generator 100 in operation with the rotor 104 in such a position that the load angle (β) is at the edge of the stability zone (i.e., at 110 degrees). FIG. 6 shows the generator 100 in operation with the rotor 104 well past the stability zone and quickly approaching a pole slip. In FIG. 6, the load angle (β) is at 270 degrees. As illustrated in FIGS. 3-6, the resultant or airgap flux (Φr) 306 is slightly distorted while the rotor 104 is in operation within the stability zone (e.g., in FIG. 4) and is grossly distorted while the rotor 104 is in operation outside the stability zone (e.g., in FIGS. 5-6).

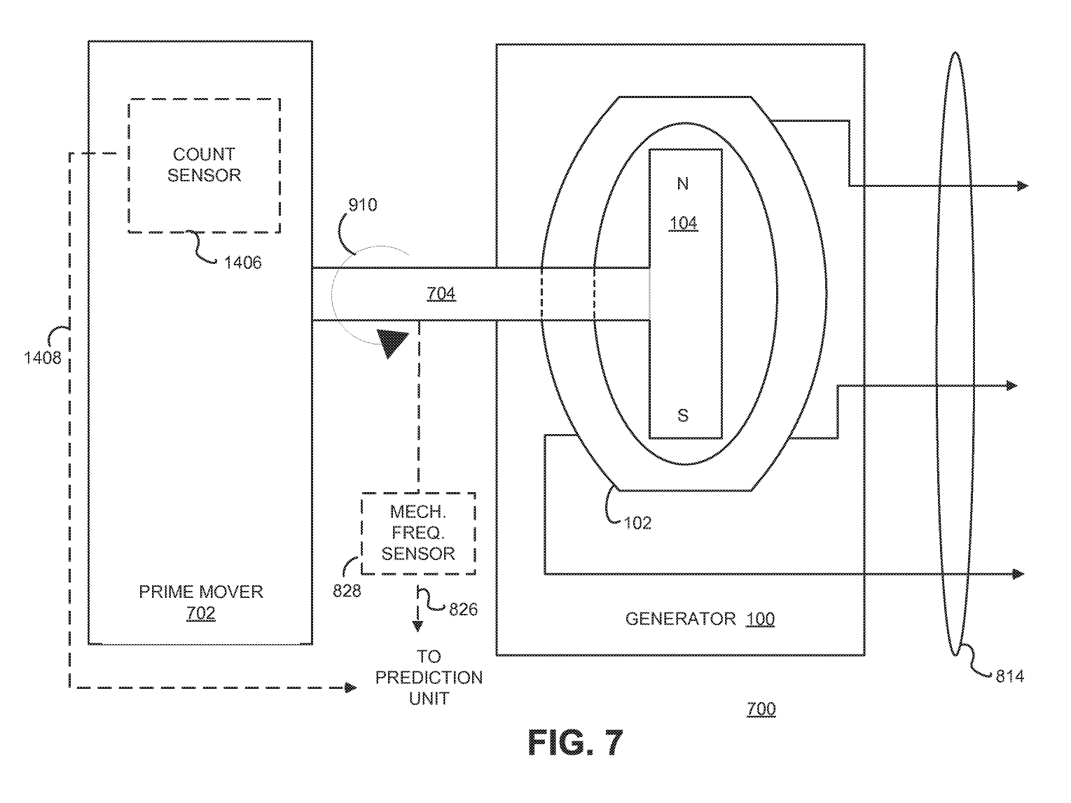

With references to FIGS. 7-10 and 14, the apparatus for pole slip protection as set forth in this disclosure is described. FIG. 7. illustrates a block diagram 700 of prime mover 702 coupled to a rotating field synchronous generator 100 in accordance with one embodiment of the present disclosure. In one embodiment, the prime mover 702 is an internal combustion engine. In other embodiments, prime mover 702 may be a gas, steam or water turbine. Other engines, turbines, and machines may also be used as prime mover 702. During operation, the prime mover 702 rotates the rotor 104 using, for example, an output shaft 704 that is mechanically coupled to the rotor 104.

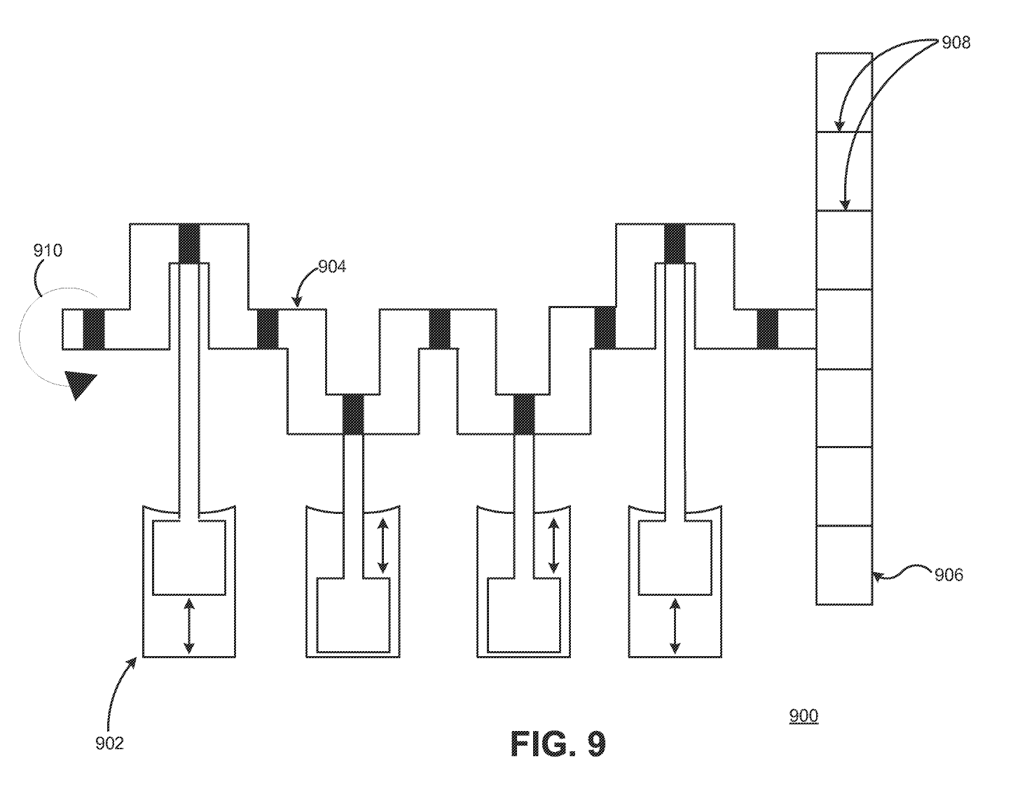

A such, prime mover 704 may include, an internal combustion engine 900 (FIG. 9) that includes a plurality of pistons 902 that are linked to a crankshaft 904. The crankshaft 904 is coupled to a flywheel 906 having a plurality of teeth 908, which engage a gear (not shown) coupled to output shaft 704. During operation, the pistons 902 in the internal combustion engine 900 drive the rotation 910 of the crankshaft 904, which in turn rotates the flywheel 906. As the flywheel 906 turns, so does output shaft 704 and rotor 104.

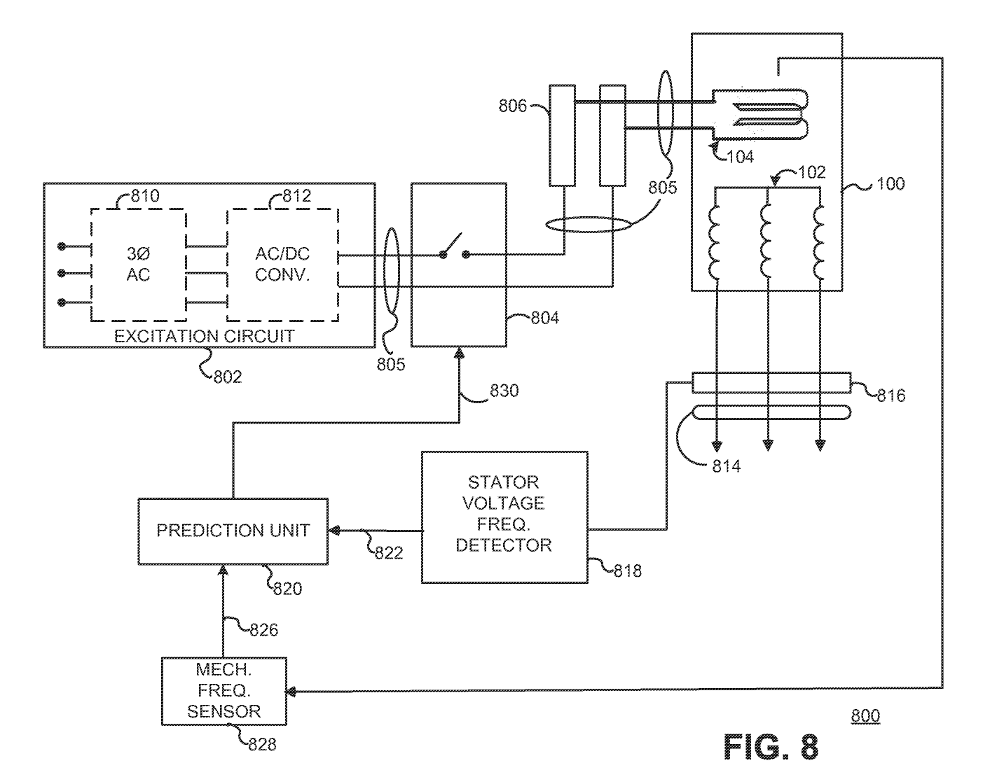

FIG. 8 illustrates a block diagram of an excitation circuit 802 coupled to the rotor 104 through circuit breaker logic 804 and a rotary electrical interface 806. The excitation circuit 802 provides the dc current 805 for the rotor windings 302 (FIG. 3). In one embodiment, excitation circuit 802 includes a three phase ac source 810 coupled to an ac to dc converter 812 such as a thyristor circuit. One of skill in the art, however, will recognize that rotor 104 may not require an excitation circuit 802 (i.e., it may include a permanent magnet instead of an electromagnet).

The dc current 805 is output to the rotor windings 302 using a rotary electrical interface 806 such as a set of slip rings and/or brushes. Other interfaces and/or excitation circuits may also be used and are contemplated by the present disclosure. As prime mover 702 rotates rotor 104, the dc current in the rotor windings 302 creates the rotor magnetic field 108, which in turn induces the three phase sinusoidal voltages 814 in the stator windings 106. The induced voltages 814 are coupled to the gird or distribution system (also known as the “mains”).

The pole slip prediction apparatus includes a pole slip prediction unit 820 that is coupled to receive stator voltage frequency signal 822 representative of the voltage output frequency at the stator windings/terminals 106. Stator voltage frequency signal 822 is generated by stator voltage frequency detector 818. In one embodiment, stator voltage frequency detector 818 is directly connected to busbar 816 and thereby receives the stator output voltages 814. As is known in the art, busbar 816 is any suitable set of conductors to which all the generators and feeders connect within a substation.

In one embodiment, pole slip prediction unit 820 also receives a rotor frequency signal 826. Rotor frequency signal 826 represents the speed by which rotor 104 is rotating (e.g., the number of revolutions per minute). Rotor frequency signal 826 is generated by a mechanical frequency sensor 828. Mechanical frequency sensor 828 may be any suitable transducer or sensor that is capable of measuring the rotational speed of rotor 104.

The rotor magnetic field 108 rotates at the rotor frequency, and the stator magnetic field 110 rotates at the stator frequency. During stable operation of generator 100, the rotation of the rotor flux (Φf) and the stator flux (Φs) should be locked or synchronous with a load angle (β) equal to approximately 45 degrees. Accordingly, the ratio of the rotor frequency to the stator voltage frequency is a constant. If the rotor frequency increases disproportionately to the stator voltage frequency, then the rotor 104 and the rotor magnetic field 108 is running faster than the stator frequency and the stator magnetic field 110 and the load angle (β) is getting bigger.

Pole slip prediction unit 820 measures the load angle (β) using the rotor frequency signal 826 and the stator voltage frequency signal 822. In particular, the load angle (β) can be determined by taking the integral over time of the difference between the rotor frequency and the stator voltage frequency. That is:

β=∫(rotor frequency−stator frequency)dt

When load angle (β) increases above 90-110 degrees or any other predetermined value chosen to avoid a pole slip, pole slip prediction unit 820 sends trip signal 830 to circuit breaker logic 804. In response to trip signal 830, circuit breaker logic 804 opens the circuit and disconnects the generator 100 from the grid.

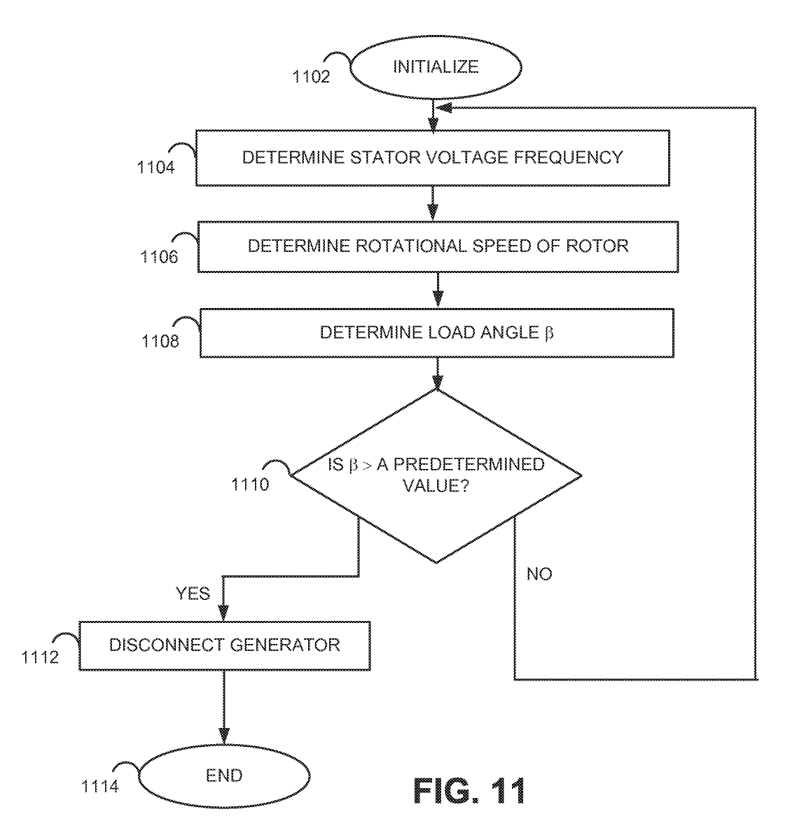

With reference to FIG. 11, an exemplary flow chart for a method of predicting a pole slip in a synchronous generator is illustrated. The method begins at block 1102 where the method is initialized. The method may be initialized by, for example, using a synchronous generator such as synchronous generator 100 and generating output voltage 814 that are induced at the stator windings 106 as described above with reference to FIGS. 1-6. The method continues at block 1104, where the frequency of the induced output voltages (i.e., the stator voltage frequency) is determined. In operation, this may correspond to using a stator voltage frequency detector 818 to determine the frequency of the induced voltages 814. One of skill in the art will recognize that block 1104 corresponds to determining the rotational speed of the stator flux (Φs).

The method then proceeds in block 1106 to determining the rotational speed of the rotor. As described above with reference to FIGS. 7-8, a mechanical frequency sensor 828 may be employed to determine the rotational speed of the rotor 104. One of skill in the art will recognize that block 1106 corresponds to determining the rotational speed of the rotor flux (Φr) and will further appreciate that blocks 1104 and 1106 are interchangeable (i.e., may be performed in reverse order or simultaneously).

Next, the method determines the load angle (β) in block 1108. In one embodiment, the load angle may be determined using pole slip prediction unit 820, which may employ suitable logic to take the integral over time of the difference between the rotor frequency and the stator frequency as β=∫(rotor frequency−stator voltage frequency)dt.

At block 1110, the method determines whether the load angle is greater than a predetermined value. For example, the method may determine whether the load angle is greater than 90 degrees. In another example, the method may determine whether the load angle is greater than 110 degrees. It is contemplated that the predetermined value may be any suitable value. In general, the predetermined value is selected as the threshold where, once the load angle is greater than the predetermined value, it is determined that a pole slip is inevitable or at least very likely to occur.

In other examples, the predetermined value may be a parameter that can be changed or adjusted according to the characteristics of the synchronous generator or according to the needs of the user. In one embodiment, prediction unit 820 allows for the predetermined value to be modified. The modification of the predetermined value can be caused through a user interface or other input mechanism by a user or can be modified automatically in response to historical data regarding the synchronous generator collected over time.

If, at decision block 1110, the answer is “no”, the load angle is not greater than the predetermined value and a pole slip is not expected, then the method returns to block 1104 and the method continues. If, however, at decision block 1110, the answer is “yes”, the load angle is greater than the predetermined value and a pole slip is expected, then the method continues at block 1112. There, the method disconnects the generator (e.g., generator 110) from the grid to avoid a pole slip. In one embodiment, pole slip prediction unit 820 may issue a trip signal 830 to circuit breaker logic 804 to effectuate the removal of the generator 100 from the grid. Those of skill in the art will recognize that the generator 100 may alternatively be shut down using other techniques. The method then concludes at block 1114 where a pole slip has been predicted and the generator has been shut down or otherwise disconnected to avoid the severe stresses that a pole slip would cause to the generator.

Pole slip prediction unit 820 may, alternatively, issue trip signal 830 when it observes that the determined load angle (β) is “trending” forward. In other words, pole slip prediction unit 820 may be configured to not issue the trip signal 830 whenever the determined load angle (β) over a given period of time is relatively stable and to issue the trip signal 830 whenever the determined load angle (β) over time is moving fast. Other parameters or trends can also be used as thresholds or triggers upon which trip signal 830 is issued. Examples of thresholds that can be used in prediction unit 820 include predetermined or given levels of the rate of change of load angle (β), spikes in the rate of change of load angle (β), or comparison of load angle (β) or the rate of change of load angle (β) to historical or the like or other saved data regarding characteristics of the synchronous generator or the like. Other thresholds or parameters known to one of ordinary skill in the art may also be used to achieve the desired operation(s) or function(s).

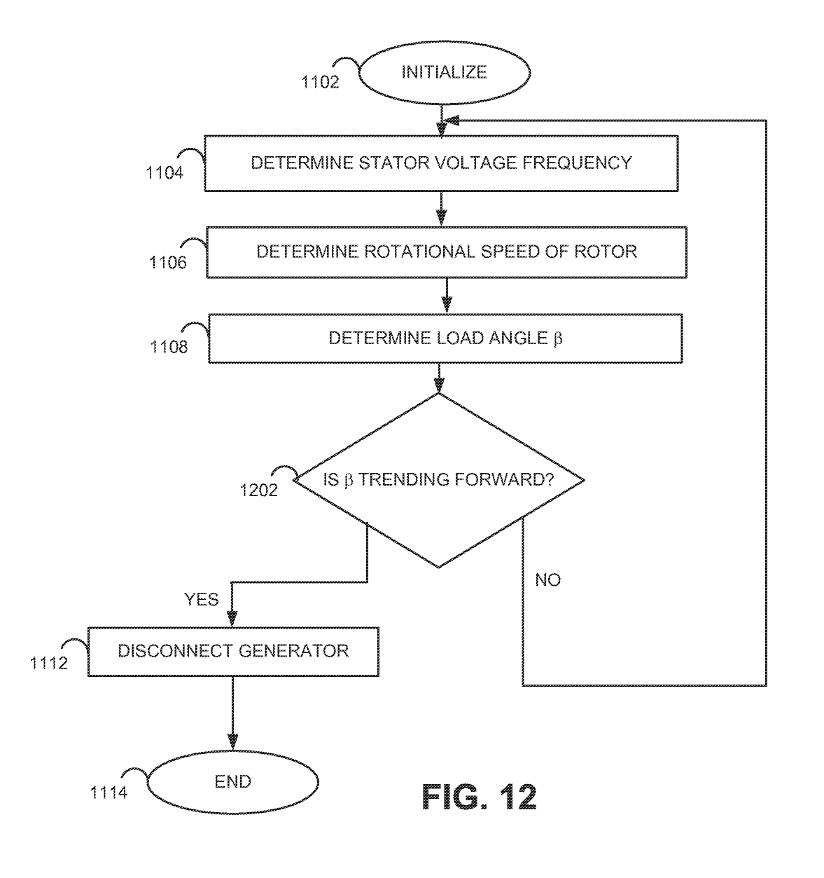

With reference to FIG. 12, another exemplary flow chart for a method of predicting a pole slip in a synchronous generator is illustrated. The method of FIG. 12 is identical to that of FIG. 11 with the exception of the decision block. Instead of using decision block 1110 as described in FIG. 11, FIG. 12 uses decision block 1202. As part of decision block 1202, the method seeks to determine whether the load angle is trending forward over a predetermined interval of time. To the extent the answer is “no”, i.e., the load angle is relatively stable over time, the method continues at block 1104. To the extent the answer is “yes”, i.e., the load angle is advancing forward at a rate that exceeds a predetermined value, a pole slip is determined to be likely and the method continues at block 1112.

One of skill in the art will appreciate that the predetermined rate may be chosen to be any value based on the tolerances of the system and generator. For example, if the observed load angles tend to insignificantly fluctuate over time without causing a pole slip, the predetermined value may be a relatively larger value. It is appreciated that pole slip prediction unit 820 may include or be coupled to suitable memory for storage and retrieval of historical or test data regarding characteristics of the synchronous generator (or similar generators) such that prediction unit 820 can determine whether the determined load angle is trending forward or staying relatively stable over a suitable interval of time. It is also appreciated that in the first pass (or first several passes) through the method disclosed in FIG. 12, decision block 1202 will yield a “no” by definition as there would be no previously determined load angles (or too few load angles) with which to compare the current load angle. Finally, it is also appreciated that any number of load angles may be used to determine whether the load angle is stable or trending forward. In one embodiment, the number of load angles used in decision block 1202 may be a system parameter that corresponds to the interval of time used to determine whether the load angle is stable or trending forward.

In both embodiments described above, the pole slip prediction unit 820 may measure the load angle (β) in real-time, i.e., with every period of the stator output voltages 814 (e.g., every 20 ms for 50 Hz countries or every 15 ms for 60 Hz countries). Those of skill in the art will recognize that the pole slip prediction unit 820 may determine the load angle (β) at any other predetermined intervals of time.

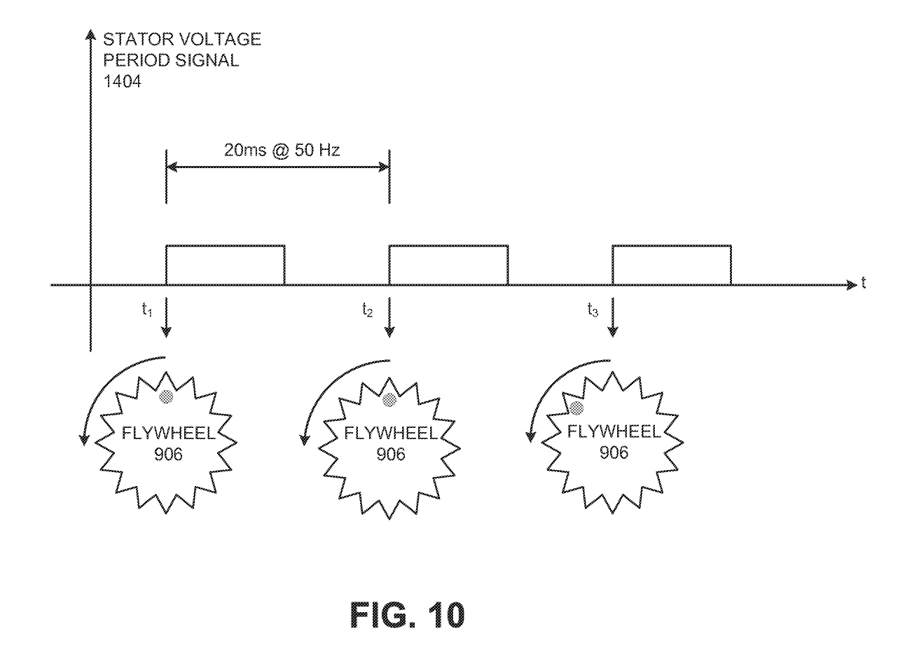

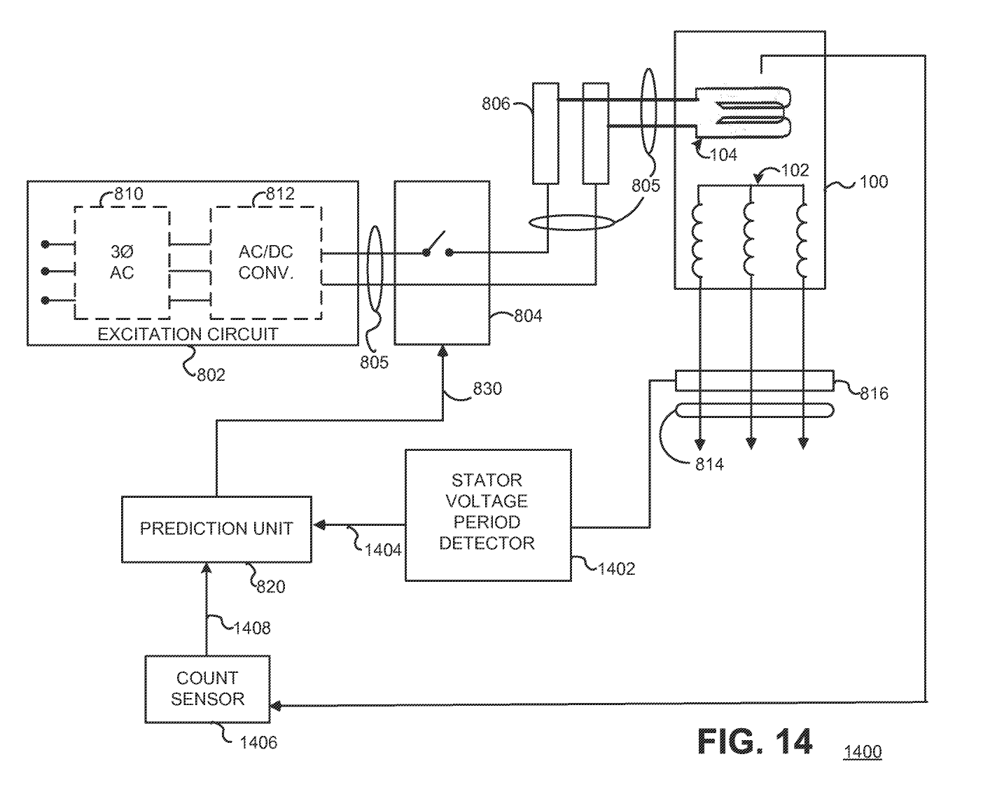

With reference to FIGS. 14 and 10, a third embodiment is illustrated. Unlike the embodiments described with reference to FIG. 8, the pole slip prediction apparatus does not include mechanical frequency sensor 828 or stator voltage frequency detector 818. Instead, pole slip prediction apparatus includes count sensor 1406 and stator voltage period detector 1402. Stator voltage period detector 1402 generates stator voltage period signal 1404 that has a period that matches the period of the stator output voltages 814. In one embodiment, stator voltage period signal 1404 generates a periodic square wave with a period corresponding to the period of the stator output voltages 814.

Count sensor 1406 may be located adjacent to flywheel 906 or any other gear coupled to output shaft 704 and generates tooth count signal 1408. Tooth count signal 1408 is, in one embodiment, a periodic square wave or impulse train where each rising edge of the square wave or each impulse represents the detection of a new tooth 908 of flywheel 906 or other gear. Count sensor 1406 can be any suitable transducer. In one embodiment, count sensor 1406 is a magnetic pick up sensor that generates a magnetic field of a particular strength and that measures disturbances in the magnetic field. As the teeth of the flywheel 906 or other gear turn during normal operation of prime mover 702, the teeth intersect the magnetic field and create a disturbance that can be observed and detected by the magnetic pick up sensor. Each rising edge of the square way or each impulse of the tooth count signal 1408 corresponds to such a disturbance in the magnetic field (or a tooth) as detected by the count sensor 1406.

Pole slip prediction unit 820 counts the number of new teeth “observed” by the count sensor 1406 for each period of the output voltages 814 using the stator voltage period signal 1404 and the tooth current signal 1408 and determines the load angle (β) using the following equation:

β={(# of Teeth Counted) mod (Total # of Teeth)}*p*360/(Total # of Teeth); where;

(# of Teeth Counted)=the number of new teeth observed for each period of the output voltage 814 as determined based on the tooth count signal 1408 and stator voltage period signal 1404;

(Total # of Teeth)=the total number of teeth on flywheel 906 or other gear, a predetermined value;

p=the number of pole pairs (e.g., 1, 2, etc.), a predetermined value;

mod=the modulo function; and

*=the multiplication operator.

As is known in the art, the expression “a mod b” gives the remainder of the division of “a” by “b.”

With reference to FIG. 10, an exemplary flywheel with 16 teeth is illustrated with a “marked” tooth to show the relative rotation of the flywheel over two periods of output ac current 814. For purposes of example, the number of pole pairs “p”=1. At the conclusion of the first period of the stator voltage period signal 1404, i.e., at t2, the flywheel has completed 1 full rotation. As such, the load angle (β)=

β=(16 mod 16)*1*360/16;

and β=0 degrees.

At the conclusion of the second period of stator voltage period signal 1404, at t3, the flywheel has made more than one full rotation and has counted 18 teeth per voltage period. As such, the load angle (β)=

β=(18 mod 16)*1*360/16;

β=45 degrees.

In one example, pole slip prediction unit 822 issues trip signal 830 whenever load angle (β) is greater than 90-110 degrees or any other predetermined value selected to correspond to an inevitable pole slip.

Pole slip prediction unit 822 may also perform a second calculation to determine whether the rotor 104 (and hence flywheel 906 or other gear) has made more than 1 rotation. In other words, with reference to the above example, the (# of Teeth Counted)=17 or 34, the above equation and the use of the “mod” function in particular has no way of determining whether the rotor 104 has made just over 1 full rotation or just over 2 full rotations for each period of the output voltages 814 (i.e., the period of the stator voltage period signal 1404). If, for example, (# of Teeth Counted)=34, the equation above will give a false positive when in fact a pole slip has already occurred. To compensate for the foregoing, protection unit 822 may simultaneously perform a second equation to identify false positives:

β2=[(# of Teeth Counted)−{1.25*(Total # of Teeth)}]*p*360/(Total # of Teeth).

Under this embodiment, if any determined (β) (i.e., (β) or (β2)) is greater than 90-110 degrees, pole slip prediction unit 820 generates trip signal 830. For example, if count sensor 832 counts 34 teeth:

β=(34 mod 16)*1*360/16

β=45 degrees.

β2=[34−{1.25*16}]*1*360/16;

β2=315 degrees.

In such an instance, β2 is well above 90-110 degrees and a trip signal 830 is generated to disconnect the generator 100 from the grid.

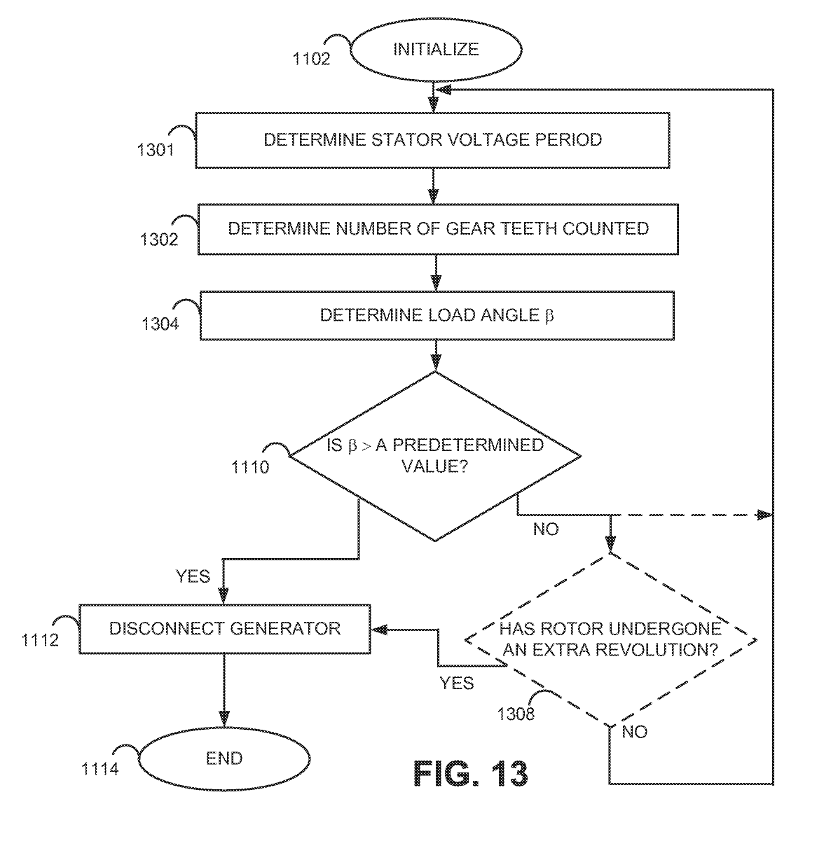

FIG. 13 illustrates another exemplary flow chart for a method of predicting a pole slip in a synchronous generator. The method includes initialization block 1102 as described above and continues with block 1301 where the stator voltage period is determined. In one embodiment, the stator voltage period is determined by the stator voltage period detector 1402, which generates a stator voltage period signal 1404. The method continues with block 1302 where the number of gear teeth (e.g., teeth 908 of flywheel 906 mechanically coupled to the rotor 104) is counted. In one embodiment, the number of gear teeth is counted by count sensor 1406, which generates tooth count signal 1408.

The method continues with block 1304 where the load angle is determined based on the stator voltage period and the number of gear teeth counted. In one embodiment, pole slip prediction unit 820 receives the stator voltage period signal 1404 and the teeth count signal 1408 and determines the load angle based on the following equation: β={(# of Teeth Counted) mod (Total # of Teeth)}*p*360/(Total # of Teeth) with variables defined above.

The method then continues with decision block 1110. If the answer at block 1110 is “yes”, then the method proceeds with blocks 1112 and 1114 as described above. If the answer at block 1110 is “no” then the method may either return to block 1104 or 1302, or alternatively, the method may include an optional decision block 1308 which determines if the decision at block 1110 yielded a false positive. In other words, block 1308 seeks to determine whether the rotor 104 has undergone an extra revolution during the course of a single period of the stator output voltage 814 such that a pole slip has already occurred. In one embodiment, pole slip prediction unit 820 determines whether the rotor has undergone an extra revolution using the (β2) equation described above.

If the answer to decision block 1308 is “yes”, a pole slip has already occurred and the method continues with blocks 1112 and 1114. If the answer to decision block 1308 is “no”, a pole slip has definitively not occurred and the method continues with blocks 1104 or 1302.

One having skill in the art will appreciate that each of excitation circuit 802, circuit breaker 804, stator voltage frequency detector 818, pole slip prediction unit 820, mechanical frequency sensor 828, count sensor 1406 and stator voltage period detector 1402 in the foregoing FIGs. may include or otherwise be comprised of logic.

Among other advantages, the above pole slip prediction apparatus and method for making and using the same efficiently predicts when a pole slips will inevitably occur in a generator before the generator is exposed to tremendous stress. In addition, the pole slip prediction apparatus and method is less expensive and complicated to implement than conventional impedance methods and can therefore be readily implemented to prolong the life of generators.

Other advantages will be recognized by one of ordinary skill in the art. It will also be recognized that the above description describes mere examples and that other embodiments are envisioned and covered by this disclosure. It is therefore contemplated that the present invention cover any and all modifications, variations or equivalents that fall within the spirit and scope of the basic underlying principles disclosed above and claimed herein.

What is claimed is:

1. A system for predicting pole slip in a synchronous generator, the synchronous generator having a rotor rotating at a rotational speed that generates a stator voltage in a stator, the system comprising:
a stator voltage frequency detector operative to determine a frequency of the stator voltage;
a mechanical frequency detector operative to determine the rotational speed of the rotor; and
a prediction unit operatively coupled to the stator voltage frequency detector and the mechanical frequency detector, the prediction unit further operative to send a trip signal to a circuit breaker to disconnect the generator from a power grid when the prediction unit determines that a probability of a pole slip condition meets a predetermined value.

2. The system of claim 1, wherein the prediction unit determines the probability of a pole slip condition by comparing the difference between the rotational speed of the rotor and the frequency of the stator voltage.

3. The system of claim 1, wherein the prediction unit determines the probability of a pole slip condition by calculating a load angle of the generator and comparing the load angle to the predetermined value.

4. The system of claim 3, wherein the predetermined value is between 90 and 110 degrees.

5. The system of claim 1, wherein the mechanical frequency detector is a count sensor operative to count a number of elements positioned on the periphery of a prime mover operatively connected to the rotor.

6. The system of claim 1, wherein the prediction unit determines the probability of a pole slip condition by calculating a rate of change of a load angle of the generator and comparing the rate of change to the predetermined value.

7. The system of claim 3, wherein the prediction unit is further operative to determine if the rotor has made an extra revolution and send a trip signal to the circuit breaker to disconnect the generator from the grid if the extra revolution has occurred.

8. The system of claim 5, wherein the prime mover is an internal combustion engine.

9. The system of claim 5, wherein the elements positioned on the periphery of a prime mover are teeth positioned on the periphery of a gear.

10. A method for predicting pole slip in a synchronous generator, the synchronous generator having a rotor rotating at a rotational speed that generates a stator voltage in a stator, the method comprising:
receiving a stator voltage frequency signal indicating a frequency of the stator voltage;
receiving a rotor frequency signal indicating the rotational characteristics of the rotor;
determining a probability of a pole slip condition based on the stator voltage frequency signal and the rotor frequency signal; and
sending a trip signal to a circuit breaker to disconnect the generator from a power grid.

11. The method of claim 10, wherein determining a probability of a pole slip condition comprises comparing the probability of the pole slip condition to a predetermined value.

12. The method of claim 10, wherein determining a probability of a pole slip condition comprises comparing the difference between the rotational speed of the rotor and the frequency of the stator voltage.

13. The method of claim 10, wherein determining a probability of a pole slip condition comprises calculating a load angle of the generator and comparing the load angle to a predetermined value.

14. The method of claim 10 wherein the predetermined value is between 90 and 110 degrees.

15. The method of claim 10, wherein the rotational characteristics of the rotor include a count of a number of elements positioned on the periphery of a prime mover operatively connected to the rotor.

16. The method of claim 10, wherein determining a probability of a pole slip condition comprises calculating a rate of change of a load angle of the generator and comparing the rate of change to a predetermined value.

17. The method of claim 10, further comprising determining if the rotor has made an extra revolution.

18. The method of claim 15, wherein the number of elements positioned on the periphery of a prime mover are teeth positioned on the periphery of a gear.

19. A synchronous generator system comprising:
a synchronous generator having a rotor and a stator, wherein the rotor has windings and the stator has windings;
an excitation current coupled to the rotor and operative to supply a dc current to the rotor windings;
a stator voltage frequency detector operative to generate a stator frequency signal representative of a frequency of the stator output voltages;
a mechanical sensor operative to generate a rotor frequency signal representative of a rotational speed of the rotor; and
a pole slip prediction unit operative to predict a pole slip based on the stator frequency signal and the signal representative of the rotational speed of the rotor.

20. An apparatus comprising:
a synchronous generator having a rotor and a stator, wherein the rotor has windings and the stator has windings;
an excitation current coupled to the rotor and operative to supply a dc current to the rotor windings;
a stator voltage period detector operative to generate a stator voltage period signal, representative of a period of the stator output voltages;
a count sensor operative to generate a tooth count signal representative of a number of gear teeth counted over a given interval of time; and
a pole slip prediction unit operative to predict a pole slip based on the stator voltage period signal and the tooth count signal.
